(19) United States
(12) Patent Application Publication
(10) Pub. No.: US 2014/0058873 A1
(43) Pub. Date: Feb. 27, 2014

(54) VIRTUAL PACKAGING AND ELECTRONIC GIFTING SYSTEM AND METHODOLOGY

(71) Applicant: SCANAVO NORTH AMERICA LTD., Calgary (CA)

(72) Inventors: Kim SORENSEN, Calgary (CA); Gwen HETHERINGTON, Calgary (CA); Ron THIELE, Airdrie (CA); David WALD, Calgary (CA); Curtis C. MULATZ, Regina (CA)

(73) Assignee: SCANAVO NORTH AMERICA LTD., Calgary (CA)

(21) Appl. No.: 13/974,015

(22) Filed: Aug. 22, 2013

Related U.S. Application Data
(60) Provisional application No. 61/691,881, filed on Aug. 22, 2012.

(51) Int. Cl. G06Q 30/06; G06F 3/0481

(52) U.S. Cl. CPC G06Q 30/0601; G06F 3/04817
USPC 705/26.1

(57) ABSTRACT

A method for electronic gifting while simulating the wrapping and unwrapping experience in the real world is provided. The method comprises creation of a virtual package, by a giver, for temporarily concealing a virtual gift icon from a recipient using a concealing overlay. The concealing overlay may comprise one or more components, at least one of which forms a temporary barrier layer over the gift icon for temporarily concealing it. The gift icon is representative of any gifitable asset. The method also enables the recipient to interact with the virtual package for removing at least a portion of the concealing overlay from the virtual package for revealing the gift icon. A system implementing the method is also provided. The system comprises modules which enables the giver to create the virtual package and the recipient to interact with the virtual package.

### CROSS REFERENCE TO RELATED APPLICATION

This application is a regular application claiming priority of U.S. Provisional Patent application Ser. No. 61/691,881 filed on Aug. 22, 2012, the entirety of which is incorporated herein by reference.

### FIELD

Embodiments described herein relate to an interactive electronic gifting methodology and more particularly to a methodology which enables creation of a virtual package for temporarily concealing a virtual gift icon from an intended recipient and interaction with the virtual package by the recipient for revealing the virtual gift icon to the recipient.

### BACKGROUND

In the age of e-commerce and shopping cart models, the gift giving experience has become depersonalized and mechanical. Gift cards are popular and can also be provided as virtual gift cards, being redeemable in whole or in part without having a physical card in hand. In such e-gifting, via a virtual gift card, a recipient is typically aware of the nature of the gift upon receipt, the added emotional value of the wonderment of discovery upon unwrapping a gift being lost. Applicant believes that the market in virtual gift cards now numbers in the billions of dollars, more than 50% of the population having received a virtual gift card. Most large retailers are offering e-gifting or are planning on implementing e-gifting, such as by offering virtual gift cards. The electronic delivery service, namely through plain text email and website landing pages with options limited to personalized messages and video attachments, has not changed. Regardless of the convenience of e-gifting, adoption resistance is attributed to the lack of interaction and personalization. Applicant has noted a general dissatisfaction by the business community with regards to the restricted delivery methods available today.

There is a desire to enhance a recipient's gift-receiving experience and an online giver's involvement in giving gifts electronically.

### SUMMARY

Embodiments described herein are directed to an electronic gifting methodology which enables an online giver to give a virtually wrapped e-gift, the actual nature of which is unknown until the recipient unwraps an icon representative of the gift. Where the gift is a virtual gift card, the icon itself can be the gift card. The giver selects and customizes a virtual package which is then created for temporarily concealing the gift icon from the intended recipient. The virtual package comprises one or a selection of one or more virtual concealing overlays. The concealing overlay is responsive to interaction by a recipient for removing the concealing overlay in a simulation of a physical unwrapping experience for revealing the gift icon and identifying the associated e-gift. The recipient can redeem the e-gift for a gift, physical or digital, through one or more conventional shopping models.

The “virtual gift icon” as described herein corresponds or is representative of any gifitable asset. The asset may be any economic resource relating to goods and/or services in the real or digital world. The asset may be a physical asset which can be redeemed in the real world or a digital asset which can be redeemed in the real or digital world. Examples of physical assets are broadly any tangible, giftable asset, such as furniture, flowers, electronic appliances, physical gift cards and the like. In the case of a physical asset, the system can be configured to direct the associated merchant to ship the asset to the recipient. Alternatively, the recipient may be directed to the merchant's brick and mortar store for collection. A digital asset may be a giftable digital gift and can include e-gift cards and other forms of virtual gift certificates or vouchers having a redeemable value associated therewith.

The redeemable value may be associated to goods or services in the real world or digital world. Examples of digital assets relating to goods may be textual, image and multimedia assets such as online games, music files, videos, movies, ringtones, and electronic books (e-books). The digital gift may or may not be associated with digital rights management, the licensing or management of which is by others. The digital asset may be redeemed in the real world or physical world. For example, if the digital asset is an electronic book, the recipient may download the book, never having physically handled the gift or, if the gift is a ticket for an event or service, the value being redeemed when the event or service occurs. If the digital asset is a virtual gift card having a monetary value associated with it (for example, a GAP® card, a registered trademark of Gap Inc., San Francisco, Calif., USA), the recipient may redeem the virtual gift card in a GAP store or through the GAP online website. Digital assets may also include a movie pass which can be redeemed at a movie theatre in the real world or as an online multimedia viewing in the digital world. Examples of digital assets relating to services may include a virtual voucher or virtual coupon whose redemption value may be services, such as household services including cleaning or renovations. It will be understood by those of skill in the art, movement and tracking of the value of the gift in the digital world, including purchase of the asset for the gifting and use by recipients, association with the gift icon, and redemption in the real world for the benefit of the recipient may be tracked using known application programs involving a unique identifier. As is already practiced in the art of virtual gift card giving and redemption, the gift is associated with a unique identifier for redemption by the specified party, for the specified value, under specified terms and conditions.

Embodiments described herein make the gift giving process more personal and less mechanical, implementing the various steps of customising the virtual gift icon by allowing the giver to select a suitable concealing overlay for temporarily concealing the gift icon and/or adding a personal message to the intended recipient. Thus, the online giver is given the notion of participating in a traditional gift giving experience. Temporarily concealing the gift icon with the concealing overlay and enabling removal of the concealing overlay enhances the gift giving experience thereby allowing the recipient to experience the steps associated with receiving a more traditional gift. Opening the digitally delivered and wrapped gift presents an emotional experience of joy and wonderment, which is often experienced when opening a physical gift. Upon receipt, the recipient cannot see the gift icon, thereby creating anticipation and excitement. The joy experienced in opening the virtual package creates positive emotions, which stimulate the brain and create happiness.

Embodiments taught herein, have the ability to create a unique experience in a digital environment through use of existing technology to create an experience not available in a physical world, such as twisting and turning of the virtual package 14 on a perfect vertical axis or being able to redo the gift opening interaction at the click of a button.

Virtual packaging also presents a “greener” alternative to sending a gift or package by reducing use of paper used for manufacturing wrapping paper, greeting cards, envelopes and the like in the real world. Embodiments are electronic and, in many cases, do not require a physical gift to be physically delivered across long distances thereby reducing fuel/energy related to delivery.

Therefore, as set forth in the embodiments described herein, virtual packaging emulates the physical world experience of presenting a “wrapped” gift to a recipient and the “unwrapping” of the gift by the recipient. Virtual packaging enables the giver to temporarily conceal the virtual gift icon from the recipient thereby creating a sense of anticipation and excitement in the recipient, the responses being similar to the emotions experienced by the recipient upon receipt of a wrapped gift in the real world.

Accordingly in one broad aspect an electronic gifting method comprises first creating a virtual package having an overlay for temporarily concealing a gift icon on a display, the gift icon associated with a gift being bestowed from a giver to a recipient, the overlay having at least one active zone embedded therein. One proceeds to notify the recipient that the virtual package is ready for access and directs the recipient to a network resource for accessing the virtual package. The method continues for tracking the movement of the recipient's pointing device at the network resource and identifying each active zone when correspondence is established between coordinates of the pointing device and the active zone X. Finally at least a portion of overlay is removed when the active zone is identified for revealing the gift icon.

In an embodiment the tracking of a recipient's pointing device further comprises tracking a control action at the pointing device, such as mouse click, when the active zone is identified, for triggering the removing step. In other embodiments, the virtual gift icons are selected a virtual gift icon database. Further, the overlay can comprises two or more components for temporarily concealing the gift icon, at least one of the components concealing the gift icon and each component having at least one of the active zones embedded therein.

In another broad aspect a electronic gifting system comprises a data store comprising one or more virtual gift icons for access by an online giver for selection of a gift icon, each of the one or more virtual gift icons corresponding to an asset; and a package customisation module enabling creation of a virtual package by temporarily concealing the selected gift icon with a concealing overlay selected from an overlay database, the overlay comprising at least one active zone embedded therein and responsive to the presence of a pointing device. A notification module is provided for notifying a recipient of the virtual package and a recipient module provides access by the recipient to interact with the virtual package, the interaction comprising tracking the pointing device over the virtual package to identify correspondence of the pointing device with the at least one active zone embedded in the overlay and control action at the pointing device associated with at least one removal action specified by the at least one active zone for removal of at least a portion of the overlay from the virtual package for revealing the gift icon.

In another broad aspect, a method for enabling electronic gift giving comprises creating a virtual package for display at a graphical user interface for temporarily concealing a virtual gift icon associated with a gift. The creating of a virtual package further comprises selecting the virtual gift icon from a plurality of virtual gift icons and selecting a concealing overlay selected from a plurality of concealing overlays for concealing the virtual gift icon. Further the method comprises notifying a recipient of the virtual package for directing the recipient to a location of the virtual package; and receiving recipient input at a graphical user interface corresponding to the location of the virtual package, the recipient input simulating unwrapping of the virtual package for removing at least a portion of the concealing overlay and revealing the virtual gift icon.

The above methodology and system can be implemented on a computer readable non-transitory medium embodying a computer program for electronic gifting, the computer program comprising program code for creating a virtual package for temporarily concealing a virtual gift icon on a display with a concealing overlay, the gift icon being associated with a gift, the concealing overlay comprising at least one active zone embedded therein and sensitive to the movement and control actions of a pointing device; and program code for tracking the movement an control actions of the pointing device over the virtual package for identifying the at least one active zone in the concealing overlay and activation of a removal control action specified by the at least one active zone for removal of at least a portion of the concealing overlay from the virtual package for revealing the gift icon.

### BRIEF DESCRIPTION OF THE DRAWINGS

FIG. 1 is a flowchart illustrating high level operations carried out by an online giver for creation of a virtual package containing a virtual gift icon and subsequent interaction therewith by the recipient for revealing of the virtual gift icon and redemption of a gift associated therewith;

FIG. 2 is a schematic illustrating an embodiment of an electronic gifting system comprising a sender module and a recipient module;

FIG. 3 is a flowchart illustrating, in detail, the interactions between the online giver and the sender module of the system of FIG. 2 for creation of the virtual package;

FIG. 4 is a schematic illustrating the virtual package created by the online giver using the sender module of the system of FIG. 2, the virtual package comprising a concealing overlay embedding one or more active zones associated with various components of the concealing overlay;

FIG. 5 is a flowchart illustrating, in detail, the interactions between the recipient and the recipient module of the system of FIG. 2 for manipulation of the virtual package created by the online giver;

FIG. 6 is a diagrammatic illustration of a screenshot from a display screen of a recipient electronic device showing the virtual package as received by the recipient;

FIG. 7 is a schematic illustration of an example of the virtual package, the virtual package comprising a concealing overlay comprising three components, a closed box, wrapping paper and a virtual string, each component comprising at least one active zone embedded therein;

FIGS. 8A to 8H are schematic representations illustrating staged removal of the concealing overlay from the virtual package of FIG. 7 by the recipient, more particularly,

FIG. 8A illustrates the closed box wrapped in wrapping paper and the string tied around an exterior of the box;

FIG. 8B illustrates untying of the string and removal of the string from the box using a pointer device controlled by the recipient;

FIG. 8C illustrates the box having the string removed therefrom;

FIGS. 8D and 8E illustrate removal of the wrapping paper from the box using the pointer device;

FIG. 8F illustrates the box having the wrapping paper removed therefrom;

FIG. 8G illustrates removal of the lid from the box using the pointer device; and

FIG. 8H illustrates a virtual gift icon contained in the box, at least a portion of the concealing overlay having been removed therefrom;

FIG. 9 is a flowchart illustrating some of the steps carried out by a program code running the recipient module of FIG. 2 which enables the recipient to remove the concealing overlay from the virtual package of FIG. 7;

FIGS. 10A and 10B are schematic representations illustrating another example of the virtual package created by the online giver, more particularly,

FIG. 10A illustrates a sealed envelope; and

FIG. 10B illustrates the envelope having been opened as a result of interaction by the recipient therewith for revealing the gift icon contained therein; and

FIGS. 11A and 11B are schematic representations illustrating yet another example of the virtual package created by the online giver, more particularly,

FIG. 11A illustrates a closed pouch; and

FIG. 11B illustrates the pouch having been opened by untying a string tied thereabout as a result of interaction by the recipient therewith for revealing the gift icon contained therein.

### DETAILED DESCRIPTION OF THE PREFERRED EMBODIMENTS

Embodiments described herein relate to a method and system for gifting in the electronic or virtual world, while simulating the wrapping and unwrapping experience in the physical or real world. While the world wide web and networks are clearly also part of the real world, the ability to transfer and enjoy assets in a virtual world without ever actually holding the “virtual” asset in your hand, is deemed to be in the virtual world as a distinction of convenience.

Embodiments described herein enable selection, configuration and generally creation of a virtual package which temporarily conceals a virtual gift icon, associated with a good or service, so as to permit an intended recipient to virtually “unwrap” the package as one would a gift in the real world. The good, of a good or service, can be generally classified as a physical or digital asset having a value to the recipient, and a service can be an asset redeemable as a service, the “asset” typically transferred as a physical or digital voucher having a value associated therewith that is temporary until fully redeemed for the specified service. Removal of at least a part of a concealing barrier layer or overlay from the virtual package reveals the virtual gift icon.

An online giver creates the virtual package through interaction and communication with a distributed network, such as the internet. The internet puts the user, the giver in this case, in communication with merchants, online program applications, and other users, such as a recipient. The users typically interact with the internet through the web and email. A giver in this case accesses the internet through an electronic device such as a computer, a graphic interface (GUI) and a program such as a browser for access and interaction with web pages and application online. Various levels of application-programming interfaces and Software as a Service, or SaaS, are online applications on the internet that facilitate the user's already well-known access to merchants for shopping for a gift, the shopping cart model, and for accessing means for creating the virtual packaging. Using such tools, the giver obtains a gift and creates a virtual package by selecting an icon associated with the gift, and applying a concealing overlay to the icon. The recipient is notified of a gift available for pickup or other form of redemption.

The recipient, is also in communication with the internet such as through a computer, GUI and browser, and is notified of the availability of the virtually packaged gift, one embodiment being through an email communication through the internet. A notification email can include a hyperlink to an application-program for unwrapping the virtual package and means for redeeming the related gift. The recipient uses their browser to access and interact with the virtual package gift, such as through their GUI, for effectively removing at least a portion of the concealing overlay to reveal the virtual gift icon. Further, instructions are generally provided as to how to redeem the actual gift or asset represented by the gift icon.

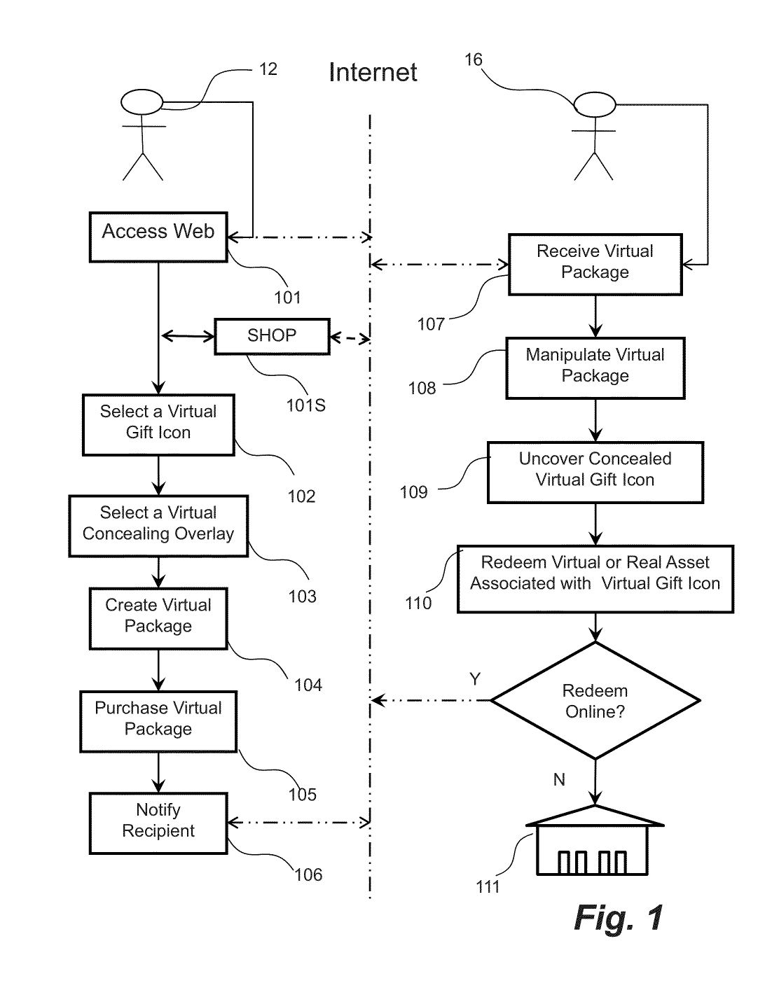

Turning to the flowchart of FIG. 1, an embodiment of some high level operations are shown as carried out by an online giver 12 for creation of a virtual package 14 and virtual gift icon 18 representing a gift, and as carried out by a recipient 16 during interaction with the virtual package 14 for revealing the gift icon 18 concealed therein.

At block 101, for the giver's interface, the online giver 12 accesses the internet such has through the world wide web and at block 101S, buys, selects or otherwise obtains a physical or digital asset or gift, such as through a merchant's conventional shopping cart model. In an embodiment, the icon may be automatically associated with a particular gift, such as if the packaging program is hosted at the merchant's site. For example, if the giver buys and e-book, a book icon is automatically assigned. At block 102, the giver is directed to a packaging application program that enables the giver to assign an appropriate virtual gift icon 18 corresponding to the gift. At block 103, the online giver 12 creates a virtual package 14 by selecting a virtual concealing overlay 20 for temporarily concealing the virtual gift icon 18. Selection can include configuring various aspects of the virtual wrapping. At block 105 the online giver 12 confirms the virtual package 14 characteristics wherein, in one embodiment, the giver 12 is directed to purchase the confirmed form of virtual packaging. At block 106, the recipient 16 is notified that they have received a virtually packaged gift and is apprised of at least the web location or hyperlink to access their virtual package 14.

Turning to the recipient's interface, at block 107, the recipient 16 accesses the internet for accessing the packaging program to receive their virtual package 14 and receipt thereof. At block 108, the recipient 16 uses their GUI to interact and manipulate the virtual package 14 so as remove at least a portion of the virtual concealing overlay 20 therefrom. By way of example, the interaction includes simulation of unwrapping of virtual wrapping, including one or more of untying of a bow, tearing paper and opening of a packaging container. At block 109, once a threshold level of removal has been achieved, the virtual gift icon 18 is revealed, the nature of which is now displayed. At block 110, the recipient 16 redeems the physical or digital asset associated with the virtual gift icon 18. At block 111, as is known in the online shopping environment, redemption of an e-gift can include an online redemption, such as for a digital asset delivered through download from a merchant site to the recipient's electronic device, or through physical access to the merchant by pickup at or shipment from the merchant's brick and mortar establishment.

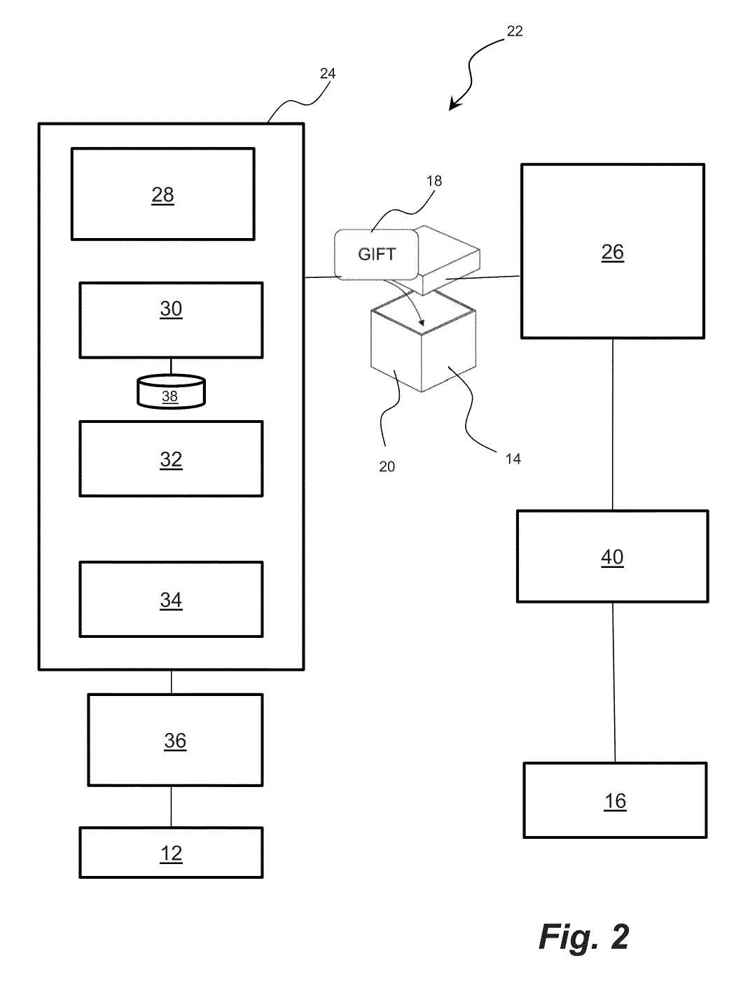

FIG. 2 illustrates an electronic gifting system 22 which enables the online giver 12 to create the virtual package 14 and to enable the intended recipient 16 to interact therewith. The system 22 comprises a sender module 24 and a recipient module 26. The sender module 24 can be accessed by the online gifter, such as through the internet, for creation of the virtual package 14. The recipient module 26 can also be accessed through the internet by the online recipient 16 for interaction with the virtual package 14.

In one embodiment and with reference to FIG. 2, the sender module 24 comprises at least a virtual packaging module 30 and further comprises a notification module 32, and a purchase or financial module 34. The virtual packaging module 30 enables the online giver 12 to virtually package the virtual gift icon 18 representing the gift. The gift is associated with the virtual gift icon 18 as part of the sender module 24 although the merchant transaction to acquire the gift may be accessed directly from the sender module 24, through a third party or the sender module 24 itself is incorporated within a merchant's own shopping cart model.

The virtual packaging module 30 involves temporarily concealing the selected virtual gift icon 18 with the virtual container or concealing overlay 20. In one embodiment, the online giver 12 selects the concealing overlay 20 by browsing a virtual packaging database 38 comprising one or more virtual concealing overlays 20. Configuration of the virtual packaging includes selecting from a variety of concealing overlay 20, that virtually represent through visual representation on the recipient's GUI, the characteristics of real world wrapping such as wrapping paper, a box, a pouch, an envelope, a balloon or any other object which can be used to form a visual barrier layer over the gift icon 18 for temporarily concealing the gift icon 18 from the intended recipient 16. The virtual packaging database 38 may comprise overlays 20 categorized as representative of various gift giving occasions. Examples of common occasions for gifting are birthdays, marriages, anniversaries, celebrations, holidays, special events, and so forth. For example, the concealing overlay 20 can be selected from various overlay types, including but not limited to virtual boxes, pouches and wrapping paper, and may be further characterized by overlay aesthetics including design, pattern or indicia including those representative of the occasion for which the gift is being given. Alternatively, one may select the type and aesthetics at the whim of the giver 12.

In one embodiment, the online giver 12 selects a virtual gift icon 18 by browsing a data store or database either a collection of gifts or gift icons associated with gifts. The sender module 24 is provided with access to a linking interface to gifts or gift icons or both, deemed herein as a gift store 28. The gift store 28 comprises an online catalog or access to an online catalog of giftable assets. The gift store 28 further comprises a database of a plurality of virtual gift icons 18, each asset or class of assets being associated with a gift icon 18. It should be understood that gifts and gifts icons 18 associated therewith, corresponding to physical or digital assets, may be associated with a single merchant or a plurality of merchants. The gift store 28 may be maintained by a merchant offering the gifts or by a third party. The gift icons 18 may be automatically assigned by the gift store or selectable by the giver 12. The online giver 12 may access the gift store 28 from a variety of electronic devices 36 (FIG. 2) including, but not limited to, a desktop computer, a laptop, a handheld computer or processor, a mobile device, or the like. In an example of a physical asset, such as a television, an automatically assigned or selected virtual gift icon 18 could be an image of a television. In an example of a digital asset, such as a virtual gift card having a monetary value associated with it, the virtual gift icon 18 is an image the virtual gift card and a currency amount. The image may contain graphics identifying the merchant. For example, if the gift card is a Starbucks® gift card, the graphics may contain the Starbucks® logo and related colors. (Starbucks® is a registered trademark of Starbucks Corporation, Seattle, Wash.)

The representative environment depicted in FIG. 2 may be implemented on a single server (not shown) on which various components of the sender module 24 and recipient module 26 reside. It should be appreciated that the system 22 may be implemented using several servers, located at numerous locations, connected via a distributed network such as the internet.

The notification module 32 enables the online giver 12 to notify the intended recipient 16 of the existence of the virtual package 14 and typically directs the recipient to the online location of the virtual package 14.

The purchasing module 34 enables the online giver 12 to purchase the virtual package 14 which has been created. Depending on the relationship between the sender module 24 and the merchant, the purchasing module 34 could be exclusive to the specified cost for the virtual packaging, or both the cost of the gift and virtual packaging thereof. Thus, as the virtual package 14 contains both the gift icon 18 and the concealing overlay 20, typically the checkout price at the purchasing module 34 includes at least the virtual packaging and can also include the price of the physical or digital asset or gift associated with the gift icon 18.

The system 22 described above may be implemented in various ways depending upon system-related and business-related constraints and may vary from one implementation to another as is understood by those of skill in the art.

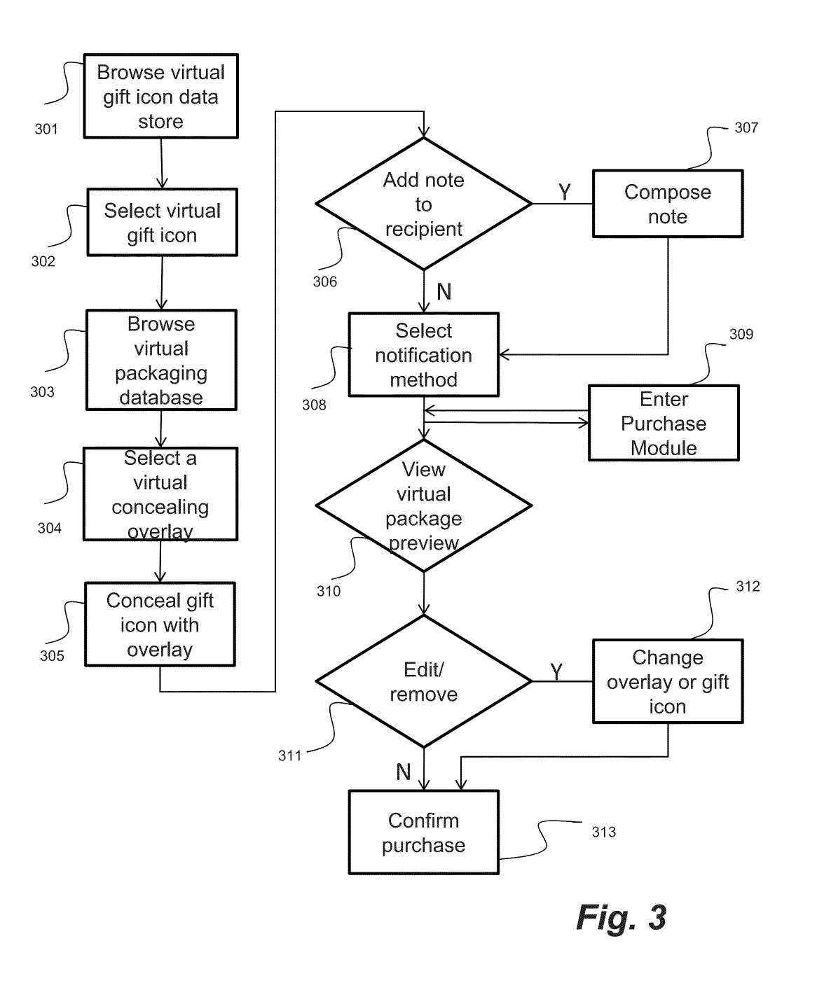

With reference to FIG. 3, communications or interactions between the online giver 12 and the sender module 24 are described for creating the virtual package 14.

At block 301, the online giver 12 accesses the sender module 24 comprising the gift store 28 using the giver's electronic device 36. The online giver 12 browses the gift store 28 for selecting the virtual gift icon 18 (block 302) which corresponds to the physical or digital asset. After the online giver 12 has selected the virtual gift icon 18, the online giver 12 is directed to the customization module 30.

At block 303, for package customization, the online giver 12 browses the virtual packaging database 38 for selection of one or more suitable concealing overlays 20. After selecting the overlay 20, at block 305, the gift icon 18 is wrapped with the concealing overlay 20 to form the virtual package 14. As is understood by those of skill in the art, the “wrapping” of the gift icon 18 may be accomplished as a single action, such as through selection from a drop-down menu or through clicking on a button or the like. The wrapping forms the virtual container for concealing the gift icon.

At blocks 306 and 307, the online giver 12 may be given an option to add a personal message or note to the intended recipient 16 to be revealed with the virtual gift icon 18.

At block 308, the online giver 12 is then directed to the notification module 32. At the notification module 32, the online giver 12 can select a method of notification from a list of notification method options for notifying the intended recipient 16 of the location of the virtual package 14.

At block 309, after the online giver 12 has selected the notification method option, the online giver 12 is directed to the purchasing module 34. The purchasing module 34 may be implemented as a shopping cart module which is known in the art and is generally described in U.S. Pat. No. 5,960,411 to Amazon.com, Inc.

At the purchasing module 34, before confirming purchase of the virtual package 14, the online giver 12 may be given further options, including but not limited to, previewing the virtual package 14 (block 310) and its behaviour when opened, changing the concealing virtual overlay or the gift icon (blocks 311 and 312) and the like.

At block 313, after the online giver 12 has made the appropriate selections, if any, the online giver 12 confirms the purchase thereby completing the transaction and interaction with the sender module 24.

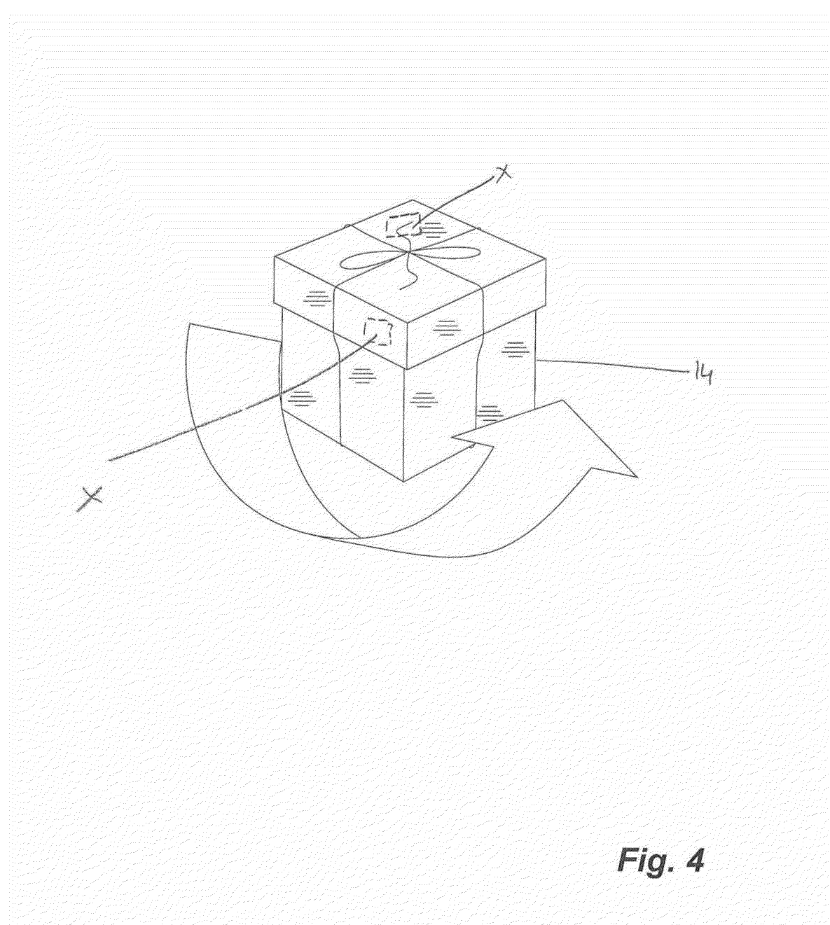

Turning to FIG. 4, an example is shown of the virtual package 14, created by the online giver 12 through interaction with the sender module 24. In an embodiment, once the virtual package 14 is received by the recipient 16, removal of at least a portion of the concealing overlay 20 is implemented by identifying at least one hot or active zone X in the concealing overlay 20. As managed by the recipient module 26, such as a packaging application program, the coordinates of a pointing device 40a on a recipient's electronic device 40 are tracked as the recipient navigates the pointing device 40a on the electronic device's screen 44. Identification of the active zones occurs as correspondence of the tracked coordinates is established relative to co-ordinates for the active zone X, identifying each active zone X. Each of the at least one active zones X encapsulates a control action. When the pointing device 40a and active zone coordinates correspond, identifying the active zone X, the pointing device 40a can be used to trigger the control action. The system can be provided with a function to determine the necessary precision of overlap or range boundaries of the corresponding co-ordinates for activation of the control action.

In embodiments, the control action is a removal action which results in removal of at least a portion of the concealing overlay 20 associated with the active zone X being identified and activated so as to reveal the gift icon 18. Removal can be a simulated removal of an overlay 20 or simulated opening of the overlay 20, both of which result in removal so as to reveal the gift icon 18.

The concealing overlay 20 may be implemented in various ways. In one embodiment, the concealing overlay 20 is a single component, such as a box, an envelope or a balloon, for concealing the gift icon 18. The single component has embedded therein at least one active zone X defining a control action.

In another embodiment, the concealing overlay 20 comprises two or more components, such as wrapping paper, a box and a ribbon, which conceal the gift icon 18. Each of the two or more components forming the concealing overlay 20, have embedded therein at least one active zone X defining a control action. At least one component or overlay conceals the gift icon. Other components may be merely decorative and would not, of themselves, result in a concealing overlay 20.

It should be understood that the two or more components of the concealing overlay 20 may be two or more concealing overlays 20, each of the two or more concealing overlays 20 having one or more components.

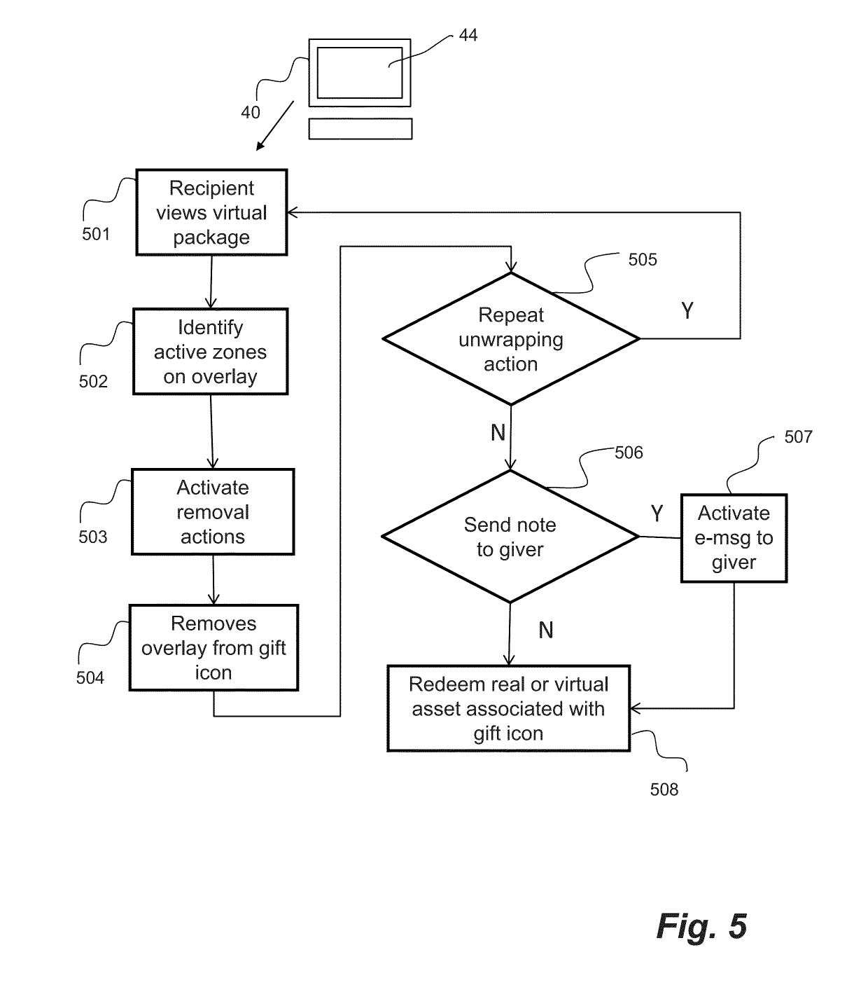

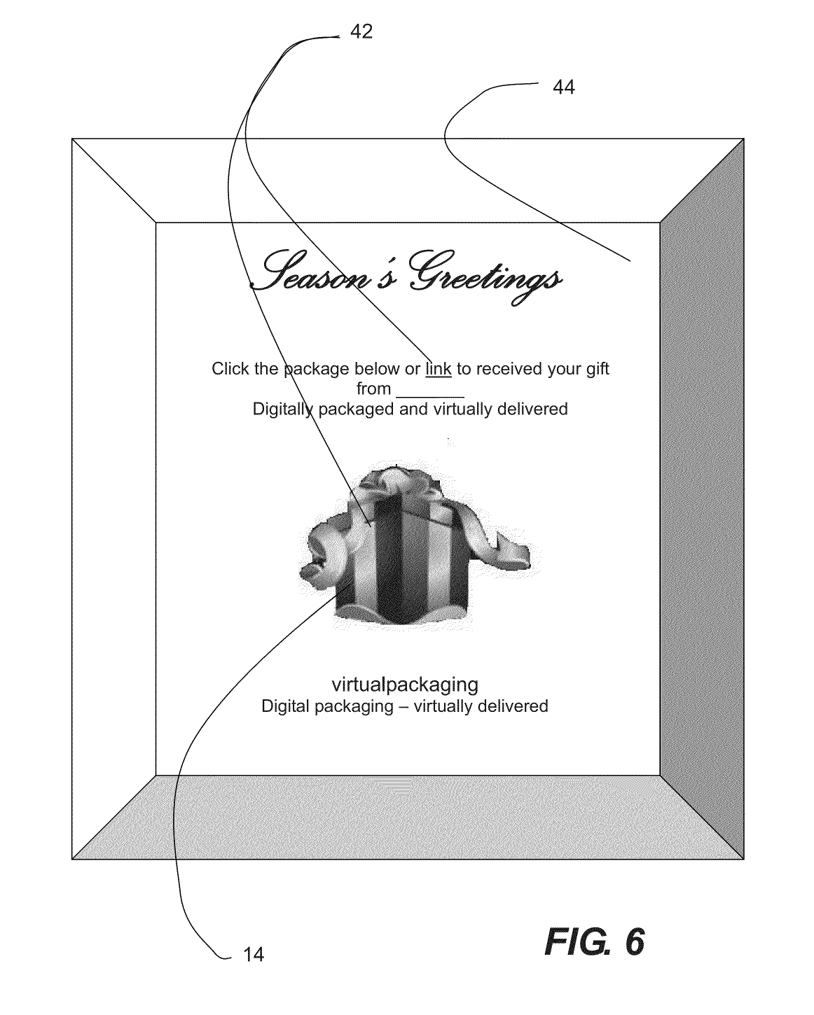

With reference to FIGS. 5 and 6, following notification, communications or interactions between the recipient 16 and the recipient module 26 are described below for removing the concealing overlay 20 from the virtual package 14.

As previously stated, the notification to the recipient triggers the interaction between the recipient 16 and the virtual package 14. At block 501, the received notification directs the recipient 16 to a location or network resource 42, such as a web page on a website (FIG. 6), hosting the recipient module 26. The recipient 16 views the network resource 42 on the screen 44 of the recipient's electronic device 40. Further, the notification may also contain instructions for manipulating the virtual package 14 for removing the overlay 20 therefrom.

At block 502, the recipient 16 uses an input controller, such as a keyboard or a mouse (not shown), associated with the recipient's electronic device 40 to navigate the pointing device 40a over the screen 44, in the region of the overlay 20, to identify the one or more active zones X embedded therein. The Correspondence between the coordinates of the tracked pointing device 40a and the active zone X, and thereby identification of the active zone X, may be indicated to the recipient 16 such as by a change in the image of the pointing device 40a on the display screen 44 to facilitate triggering or activation of the control actions associated therewith.

At block 503, on locating the one or more active zones X, indicated by the change in the cursor image such as to a manipulation icon or a rotating circle, the recipient 16 uses the input controller to trigger the control action specified by the active zone X. In one embodiment, the pointing device 40a is a cursor and the input controller is a mouse at the active zone X. In this embodiment, the control actions are triggered, such as by the recipient 16 clicking the mouse. The control actions typically removal actions, may, for example, simulate untying of a virtual string, tearing of virtual decorative wrapping paper, popping of a virtual balloon, lifting a virtual lid from a virtual box and the like.

At block 504, the triggering of the control actions in the active zones X results in removal of at least the portion of the concealing overlay 20 associated with the active zones X, as explained above, and ultimately results in the gift icon 18 becoming visible to the recipient 16.

At block 505, the recipient 16 may be given an option, at the recipient module 26, to repeat the steps involved in the unwrapping operation.

At blocks 506 and 507, the recipient 16 may be also given an option, at the recipient module 26, to send a note or message, such as a Thank You note, to the online giver 12.

At block 508, the recipient module 26 may also provide options for the recipient 16 to redeem the physical or digital asset associated with the gift icon 18. For example, if the asset associated with the gift icon 18 is a virtual asset, such as an iTune, the recipient module 26 may include instructions as to how to download the iTune. If the asset associated with the gift icon 18 is a real asset, for example, a TV, the recipient 16 may be given options as to how to redeem the asset. One option may be to have the merchant, associated with the TV, deliver the TV to an address provided by the recipient 16. Alternatively, the recipient 16 may be directed to a bricks and mortar store for redemption.

The application program or program code, used for implementing the customization module 30 and the recipient module 26, attempts to characterize or simulate the actions of a live event. In this case, the live event comprises two steps; a first step of selecting and packaging a gift by a giver and a second step of unwrapping the gift by a recipient in the real or physical world. The code implements an interactive computer simulation of the live event at the electronic device 36 of the online giver 12 and at the recipient's electronic device 40. Techniques for identifying actions and parameters for any particular type of event are well known to those skilled in the art of special-purpose languages.

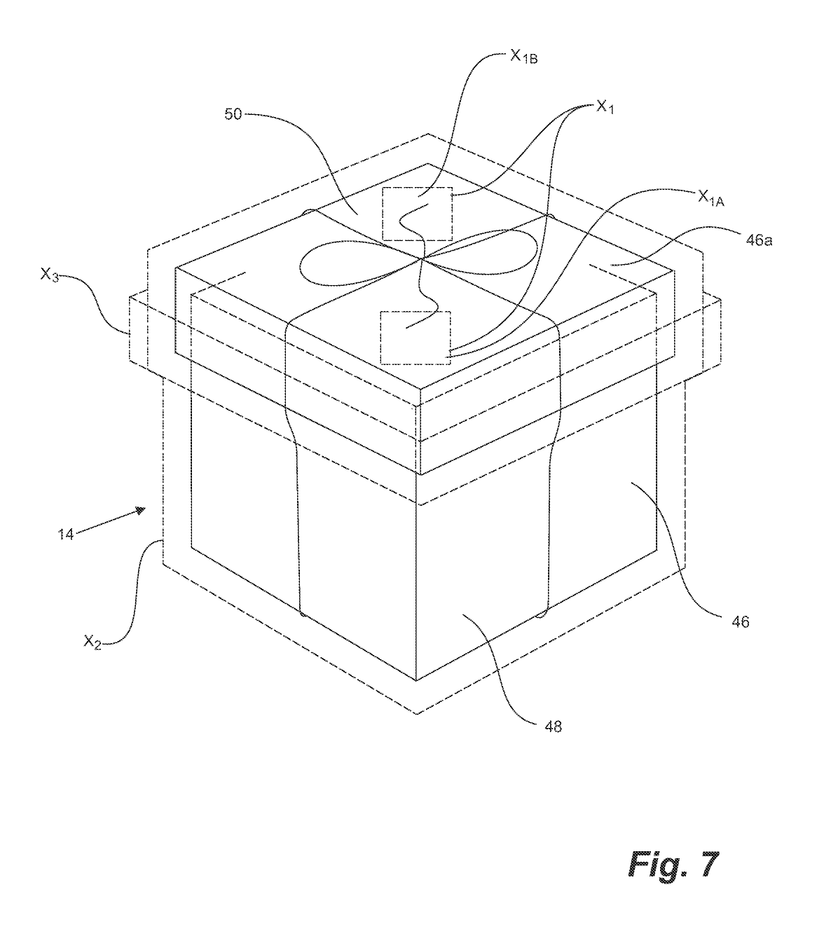

By way of example and having reference to FIGS. 7, 8A-8H and FIG. 9, various steps involved in removal of the concealing overlay 20 are explained in greater detail below.

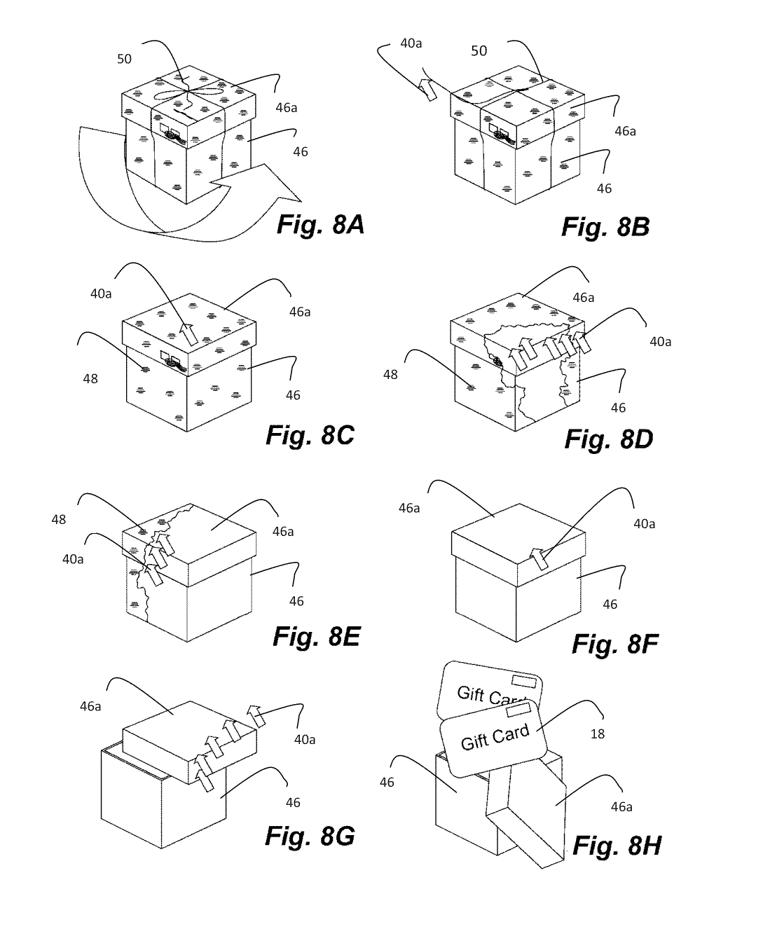

Best seen in FIGS. 8A-8H, the recipient module 26 enables the recipient 16 to access and interact with the virtual package 14. The notification received from the sender module 24 triggers interaction between the recipient module 26 and the recipient 16. The recipient 16 typically interacts with the recipient module 26 through the pointing device 40a, such as a cursor, associated with the electronic device 40 used by the recipient 16. Recipient interaction with the virtual package 14 includes at least removal of at least a portion of the concealing overlay 20 from the virtual package 14 through manipulation of the pointing device 40a which is tracked by the electronic device 40 to permit manipulation of the virtual package 14.

With reference to FIGS. 7 and 8A, in one example, a virtual package 14 has been created by the online giver 12 for manipulation by the recipient 16. This example of concealing overlay 20 comprises a plurality of components and virtual characteristics, including a box 46, a lid 46a for the box 46, wrapping paper 48 and a string 50.

In the broadest instance, the online giver 12 creates the virtual package 14 by indicating a virtual package 14 is to be generated, relying on system defaults. In a generic case, a default package 14 may include a default gift icon, perhaps displaying a value and a merchant contained within the aforementioned box 46, paper 48 and string 50.

In a more interactive case, the giver can select components having individual characteristics. The creation of the virtual box 14 can be animated for entertainment of the giver 12 through a display of the placing of the selected gift icon 18 in the box 46, closing the box 46 with the lid 46a, wrapping the closed box 46 with the wrapping paper 48 and tying the virtual string 50 around the wrapped, closed box 46. In another embodiment, the giver 12 could be given the option to manipulate the packaging through interaction with the selected components for placement of the selected gift icon 18 in the box 46, closing an open end of the box 46 with a lid 46a, an applying or wrapping of the closed box 46 with the wrapping paper 48 and an applying or tying the virtual string 50 around the wrapped, closed box 46.

These actions are executed by the online giver 12 through an input controller, such as a mouse or keyboard, associated with the giver's electronic device 36. The various actions stated above may be made available to the online giver 12 as a list of selectable actions and optional concealing overlays 20. The actions may be executed by a single operation of the input controller or may be a series of operations. The concealing overlay 20 includes at least one component or characteristic, such as a container for the gift icon 18. One concealing overlay 20 can be combined with one or more additional overlays 20, each adding a characteristic to the virtual packaging 14. Alternatively, a concealing overlay 20 can already include two or more characteristics including wrapping paper 48 and a string 50, or a container such as a box 46, wrapping paper 48 and string 50. Herein, in the context of the removal or overlays and components, the term overlay 20 can be synonymous, the removal of an overlay 20 also including removal of a component of an overlay 20 as the context would dictate.

The giver 12 can select the level of interaction required by the recipient 16 through their choice of the various components or characteristics available with the selected concealing overlay 20. The level of interaction includes the number of components and overlays 20 and how the recipient 16 is expected to interact therewith for removal.

Each overlay 20 is embedded with at least one active zone X for removal of that particular component. In this example, the selected gift icon 18 is an image of a gift card. As shown in FIG. 7, the string 50 is embedded with active zones X_{1A} and X_{1B}. The lid 46a is embedded with active zone X₂. The wrapping paper 48 is embedded with active zone X₃. The pointing device 40a is a cursor and the recipient 16 controls movements of the cursor 40a such as through an input controller, including but not limited to a mouse, touchscreen movement or track pad.

### EXAMPLE

With reference to FIGS. 7, 8B-8H and 9, an example is provided of a series of steps performed by the recipient 16 to remove the various components of the concealing overlay 20 from a box-like implementation of the virtual package 14.

After virtual package 14 has been created, the recipient 16 is sent a notification. An example of a notification is an email sent to and received by the recipient 16 on his electronic device 40. The notification contains instructions for viewing and opening the virtual package 14. The recipient 16 accesses and views the virtual package 14 on his electronic device 40 by following the instructions. In this scenario, the program code implementing the virtual package 14 is such that the recipient 16 is enabled to click, grab and hold the virtual package 14 while moving the cursor 40a, such as in a side to side motion, to make the virtual package 14 rotate on a vertical axis. The recipient 16 is also enabled to locate and hold onto the string 50 on the virtual package 14 by depressing or clicking the control button on the mouse. This action triggers a control action specified by the active zone X_{1A}. X_{1B} associated with the string 50. The action translates into pulling the string 50 to another part of the active screen 44 away from the virtual package 14. When the recipient 16 un-clicks the control button on the mouse, the string 50 falls to the bottom of the display screen 44 of the electronic device 40. The recipient 16 scrubs back and forth by clicking the mouse and moving the cursor across the paper 48 to tear the wrapping paper 48. The paper disappears where the cursor 40a contacts the active zone X₃ embedded in the wrapping paper 48 component, while also creating a tearing sound. In this implementation, the program code is structured such that the recipient 16 can click, tear and un-click to a threshold action, such as to a maximum of five (5) times, at which point all the wrapping paper 48 will disappear. The recipient 16 can hold onto the lid 46a by clicking and moving the cursor. When open sufficiently or when the recipient 16 un-clicks the mouse, one or more virtual gift icons “pop” out of the box 46 and stay on the screen 44 for the recipient 16 to read. The lid 46a can fall to the bottom of the screen 44 when the mouse is released. In this instance, two gift icons are displayed, one of which also act as a message card. The message card is shown to contain a custom text from the online giver 12.

The gift icon 18 may contain information about the physical or digital asset associated therewith and may contain instructions to activate redemption for example “click here to redeem your product”. In this scenario, when the recipient 16 clicks to redeem, a new window opens in the browser, taking the recipient 16 to a product redemption page. For amusement, the recipient 16 also has an option to repeat the steps of unwrapping the virtual package 14 and re-interact with the virtual package 14.

With reference to FIG. 8B, the recipient 16 navigates the cursor 40a in the region of the string 50 to detect either active zone X_{1A} or X_{1B} embedded in the string 50. The navigation is tracked to that the coordinates of the cursor 40a can be corresponded to the coordinates of the active zones X_{1A} or X_{1B} to identify or detect the active zone X_{1A} or X_{1B}. Indentification is indicated by the change in the displayed characteristics of cursor or component, for example, by a change of the image of the cursor 40a to a rotating circle. The recipient 16 activates the cursor 40a in the active zone X_{1A} or X_{1B} by depressing a control button on the input controller. This activation results in removal of the string 50 from the box 46. In an embodiment, the activation of separation of the string 50 (removal action) is achieved by clicking the control button on the mouse once. In another embodiment, the activation of the separation of the string 50 is achieved by depressing the control button on the mouse to engage the cursor 40a one of the active zones for the string 50 and thereafter moving the mouse while continuing to depress the button which translates into dragging the string 50 from the box 46 until the string 50 separates itself from the box 46.

With reference to FIGS. 8C to 8E, the recipient 16 thereafter removes the wrapping paper 48 from the closed box 46 by identifying the active zone X₂ embedded in the wrapping paper 48 and scrubbing the tracked mouse across the screen 44. The recipient 16 triggers the control action specified by the active zone X₂ using the mouse as described for the string 50. In this example, the control action specified by X₂ is depicted as disappearance of the wrapping paper 48 from the closed box 46 simulating a tearing of the paper therefrom. The control action can also accompanied by presenting audio that is symbolic of the removal actions, such as simulating the sound of tearing of wrapping paper in the real world.

With reference to FIG. 8G, after the wrapping paper 48 has been removed, the recipient 16 removes the final component of the concealing overlay 20, the lid 46a. The recipient 16 navigates the tracked mouse over the overlay 20 to identify the active zone X₃ embedded in the lid 46a and uses the mouse to trigger the control action associated with X₃. Detachment of the lid 46a completes removal of the concealing overlay 20 from the virtual package 14 which results in the gift icon 18 being visible to the recipient 16.

As illustrated above, active zones X can be assigned with specified control actions which mimic or simulate the real world behavior including attaching to ends of ribbon or string 50 and a lower edge of the lid 46a being responsive to an upwardly lifting action. Alternatively, identifying of the active zones X can be a mere one step trigger for a complete removal action, or be associated with a counter or timer for assured and complete removal in a predetermined, reasonable number of actions or time. Counters assure removal while avoiding issues related to operator and device-to-device variability.

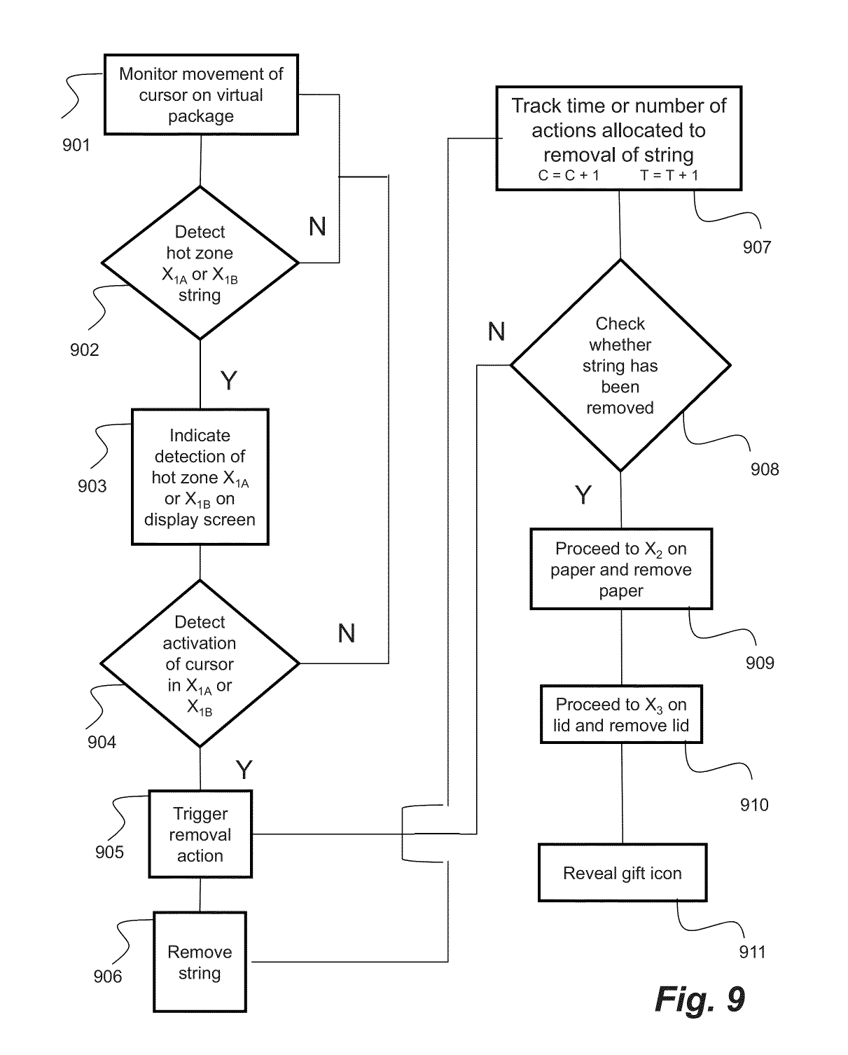

FIG. 9 depicts some of the steps executed by a program code controlling the recipient module 26 during removal of the concealing overlay 20 from the virtual package 14. The steps are explained in conjunction with the example depicted in FIGS. 7 and 8A-8H.

Referring to FIG. 9, and at block 901, movement of the cursor 40a around the virtual package 14 on the display or screen 44 is tracked or monitored for a first concealing overlay 20, in this case being an example of a string 50. The string 50 is the first of several components, the string being an outermost component that requires removal before accessing a second intermediate wrapping paper component and a third, innermost box and lid component.

At block 902, presence or encroachment of the cursor 40a in active zone X_{1A} or active zone X_{1B} for the string 50 is detected. The overlay or component representing the string 50 conceals underlying overlays 20 or components, such as those representing the wrapping paper 48 and the box 46. Any active zones for underlying or inner components and overlays 20 are deactivated pending removal of superior or outer components or overlays.

At block 903, detection of the active zone X_{1A} or X_{1B} is identified on the display screen 44 by the change in the displayed image, such as that of the cursor 40a on the display screen 44. At block 904, activation of the cursor 40a in active zone X_{1A} or X_{1B} is detected such as by matching corresponding coordinates of the cursor 40a and of the active zone X.

At block 905, removal action associated with the active zone X_{1A} or X_{1B} is triggered. At blocks 906 and 907, the string 50 is removed. Completion of the removal action associated with the active zone X_{1A} or X_{1B} is tracked. A counter associated with this removal step may be configured to stop after a predetermined number of removal actions or a time frame.

At blocks 908 and 909, after it has been verified that the removal action associated with active zone X_{1A} or X_{1B} is completed, the recipient 16 is prompted to move to the next component or overlay 20 associated with its own active zones X, in this example being active zone X₂ for the wrapping paper 48.

The steps depicted in blocks 901 to 908 are repeated until the wrapping paper 48 is removed.

At blocks 910 and 911, the recipient 16 proceeds to the next component and associated active zone X₃ for the lid 46a for removal thereof. Removal of the lid 46a completes removal of the various components of the one or more concealing overlays 20 thereby revealing the gift icon 18 to the recipient 16.

### Examples

### Alternate Overlays

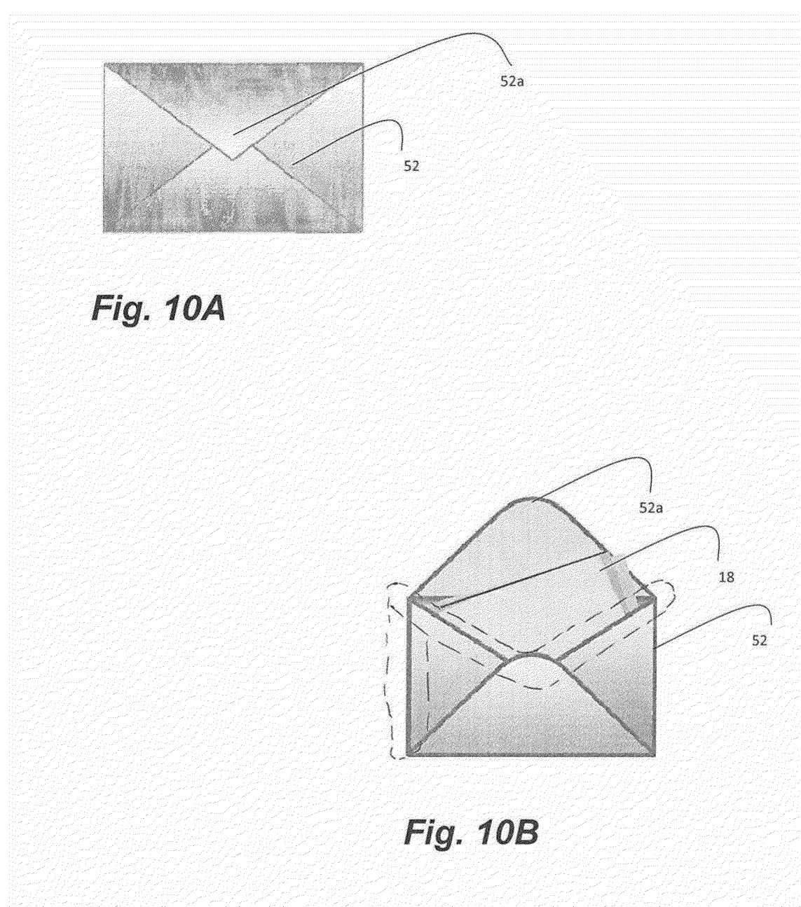

FIGS. 10A and 10B illustrate another example of the virtual package 14. In this example, the selected concealing overlay 20 is a virtual envelope 52. The envelope 52 acts as the container for the gift icon 18. As shown in FIG. 10A, the selected gift icon 18 is located in the envelope 52 and virtually sealed therein with a sealing flap 52a of the envelope 52. As shown in FIG. 10B, the recipient 16 uncovers or reveals the gift icon 18 contained within the envelope 52 by identifying the active zone X such as that embedded about the sealing flap 52a of the envelope 52 and activating the removal action specified by the active zone X which approximates opening of the sealing flap 52a.

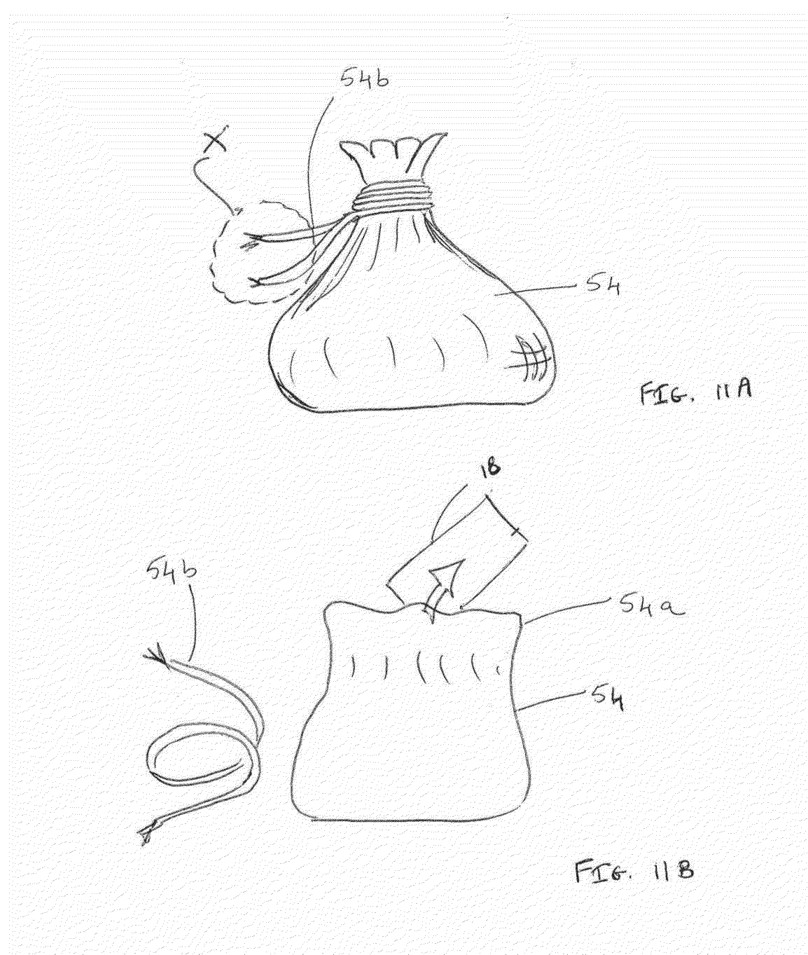

FIGS. 11A and 11B illustrate another example of the virtual package 14. In this example, the concealing overlay 20 is a virtual pouch 54. The virtual package 14 is selected by the online giver 14. As shown in FIG. 11A, a virtual string 54b, is tied about an open end 54a of the pouch 54. As shown in FIGS. 11A and 11B, when received, the recipient 16 uncovers the gift icon 18 contained within the pouch 54 by identifying the active zone X embedded in the virtual string 54B by moving the cursor 40a thereover and activating the removal action specified by the active zone X, such as by clicking thereon, which approximates separating the string 54b from the pouch 54 and which opens the pouch 54 to reveal the gift icon 18.

As depicted in the drawings, the virtual package 14 may be implemented in various forms and the recipient 16 may interact with the virtual package 14 in different ways.

For example, removal of the string 50 from the box 46 may be depicted in various ways. In one embodiment, the string 50 may be depicted as exploding and disappearing when an active zone X in the string 50 is activated. In another embodiment, activation of an active zone in the string 50 may enable the recipient 16 to drag the string 50 away from the box 46 with the cursor 40a, and the string 50 may be depicted as disappearing after a preset or predetermined time or after it reaches a particular distance from the reference coordinates of the box 46. In another embodiment, when the active zone X in the string 50 is triggered, the image of the cursor 40a may change to that of scissors and the recipient 16 may be able to trigger the control action which simulates cutting the string 50. Others could include simulating a control action to drive a pin into a concealing overlay such asa balloon.

The concealing overlay 20 may comprise the two or more components, components could also be akin to “skins”, forming the concealing overlay 20. The recipient 16 may interact with the virtual package 14 in multiple ways such as through the input controller to simulate a variety of control actions such as a shaking interaction, exploding interaction or floating interaction for separating or removing at least a portion of the concealing overlay 20 from the virtual package 14. Movement of the virtual package 14 on the screen 44 may be responsive to an orientation of the recipient's electronic device 40. For example, if the recipient's electronic device 40 is a smart phone, the virtual package 14 may be responsive to the movement of the smart phone. The program code implementing the recipient module 26 has the ability to scale to any type of interaction between the virtual package 14 and the recipient 16 for removing the concealing overlay 20.

The recipient module 26 may be implemented using one or more of the following technologies such as HTML 5 game design technology, jQuery and Paper.js, Adobe Photoshop and Autodesk Maya. On-screen movement of the various virtual objects associated with the virtual package 12 (for example, the box 46, the string 50, the lid 46a, the wrapping paper 48) may be designed using at least one of the following techniques: Sprite animation (using multiple images shown in sequence to simulate rotational movement of box); CSS (Cascading Style Sheets) animation (to manipulate various positions, sizes and opacity of the virtual objects); Canvas drawing animation, to draw and erase lines and shapes on the screen in sequence in response to recipient interaction, such as demonstrated in FIGS. 8A-8H, or Javascript framework developed to track user interaction, sequence events, and enable animation of the virtual package 14.

The following paragraphs describe additional variations associated with various modules of the system 22 and/or steps of the methodology described herein.

The sender module 24 may be implemented using an iframe technology (e.g., by embedding a document within another document) whereby the online giver 12 may be able to view or provide information, such as information regarding selection of gift items and overlays, credit card information, notification or handling information, and the like, in a single browser window embedded in the mark-up language page, without leaving the mark-up language page of the host website. The single browser window may have multiple panes, such as a virtual gift item pane, an overlay pane, a notification information pane, a credit card information pane, that may have a drop down form or forms which the online giver 12 may activate (e.g., by selection) and provide fill-in information, such as notification information, and credit card information.

Applicant has contemplated various ways of notifying the intended recipient 16 of the virtual package 14. In one embodiment, the recipient 16 may be notified by an electronic notification. The electronic notification may be selected from a group of a variety of possible options including but not limited to e-mail, text message, a voicemail message, or other electronic message. In another embodiment, the recipient 16 may be notified by physically delivering to the recipient 16 a print out containing a link or access code to the web page 42. In yet another embodiment, the recipient 16 may be notified by facsimile. The facsimile may contain a link or access code to the network resource or web page 42.

In another example, wherein the recipient 16 is notified of the virtual package 14 by email, the subject line of the email may contain an indication as to the nature of the physical or digital asset associated with the gift icon 18. The body of the email may contain graphic or a link to the page 42. The graphics may be associated to branding of the physical or digital asset associated with the gift icon 18. For example, if the gift item is a Starbucks (trademark of Starbucks Corporation, Seattle Wash.) gift card, the graphics may contain the Starbucks logo and related colors. The email may also contain instructions to redeem the gift item and/or a personal message from the online giver 12.

In yet another embodiment, the notification module 32 may be configured to notify the recipient 16 of the virtual package 14 the moment the transaction is completed at the purchasing module 34. Alternatively, in another embodiment, the notification module 32 may be configured to notify the recipient 16 of the virtual package 14 after the expiry of a predetermined or preset timeframe from the completion of the transaction at the purchasing module 34, or on a specific date, such as on a birthday.

In yet another embodiment, the purchasing module 34 may be associated with a tracking module (not shown) which may capture, track, record, communicate, store, monitor, analyze, or otherwise financial data or meta data associated with the transaction initiated by the online giver 14.

In yet another embodiment, the sender module 24 and the recipient module 26 may each be associated with one or more record modules (not shown) that may store at least some data for subsequent retrieval. Examples of data stored are: sender (online giver) name, sender email address, sender meta data (location, web information, time, date), recipient name, recipient email address, details regarding the physical or digital asset associated with the gift icon 18, details regarding the gift icon 18 and overlay 20, date and time of delivery of the virtual package 14, price of the physical or digital asset associated with the gift icon 18, price of the concealing overlay 20, details relating to the vendor offering the physical or digital asset associated with the gift icon 18 and the like.

In yet another embodiment, the recipient module 26 may further comprise a communication module which links back to the sender module 24, adapted to send a message to the sender module 24 when the virtual package 14 is viewed by the recipient 16 or when the physical or digital asset associated with the gift icon 18 is redeemed by the recipient 16. The sender module 24 may be further adapted to send a reminder to the recipient 16 if the sender module 24 does not receive a message from the communication module within a preset timeframe.

In yet another embodiment, the system 22 may be equipped with various ways to track movement of the virtual package 14 between the sender module 24 and the recipient module 26. In one embodiment, the virtual package 14 is associated with an unique identifier which enables tracking of the virtual package 14 between the various components of the sender module 24 and the recipient module 26. The unique identifier may provide information regarding the merchant, the identity of the online giver 12, the identity of the recipient 16, details relating to the physical or digital asset associated with the gift icon 18 including value and details relating to redemption of the physical or digital asset associated with the gift icon 18 and the like.

The Applicant has contemplated various ways of implementing the sender module 24 and the recipient module 26. Implementation may be driven by business arrangements between the Applicant and the merchants of the physical or digital assets associated with the virtual gift icons 18.

In one embodiment, the sender module 24 may be implemented wherein the sender module 24 components are implemented on a website maintained by the Applicant or a designate thereof. The virtual gift icon database 28 contains gift icons 18 associated with physical or digital assets from a dedicated merchant or a plurality of merchants. If a gift and virtual package 14 is sold, sales takes place at the Applicant's website and payment is collected at the Applicant's website without redirection to another website. At least a portion of the sale value is remitted to the merchant whose physical or digital asset was purchased. Funds could be transferred in batches or after each sale. Preferably, the funds are transferred in batches to reduce transfer fees or other costs. Cost for virtually packaging the gift icon 18 is included in the check out price, where applicable. The price includes applicable local taxes such as goods and services taxes.

In another embodiment, the sender module 24 may be implemented wherein a merchant hosts a website comprising a plurality of physical or digital assets linked or associated with virtual gift icons 18. The host website implements the various components of the sender module 24 as add-ons to the host website. If a virtual package 14 is sold, sales take place at the host website and payment is collected thereat for distribution.

In another embodiment, the sender module 24 may be implemented wherein a merchant hosts a host website comprising physical or digital assets and the virtual gift icon database 28 containing gift icons associated with the assets. The host website gives an option to a potential online e giver as to whether the online giver wishes to customize his virtual package. If so, the online giver is directed to a website maintained by the Applicant. Applicant's website implements at least the customization module 30 for creation of the virtual package 14. In this embodiment, the asset associated with the gift icon 18 can be digital asset and the recipient 16 redeems the asset at the merchant website. A call is sent from the merchant site to the Applicant's website indicating that the asset has been redeemed. The Applicant's website marks the transaction as redeemed and stores information in secure database.

In one embodiment, the sender module 24 and the recipient module 26 may be different page views of a website maintained by the Applicant or a third party.

In another embodiment, the sender module 24 and the recipient module 26 may be different websites maintained by the Applicant, merchant or a third party. The modules may be implemented on a single server or multiple servers.

The embodiments of the invention for which an exclusive property or privilege is claimed are defined as follows:

1. An electronic gifting method, the method comprising:
creating a virtual package having an overlay for temporarily concealing a gift icon on a display, the gift icon associated with a gift being bestowed from a giver to a recipient, the overlay having at least one active zone embedded therein;
notifying the recipient that the virtual package is ready for access;
directing the recipient to a network resource for accessing the virtual package; and
tracking a recipient's pointing device at the network resource and identifying each active zone when correspondence is established between coordinates of the pointing device and the active zone X; and
removing of at least a portion of overlay when the active zone is identified for revealing the gift icon.

2. The method of claim 1 wherein the tracking a recipient's pointing device further comprises tracking a control action at the pointing device, when the active zone is identified, for triggering the removing step.

3. The method of claim 1 wherein the creating of the virtual package further comprises selecting the virtual gift icon from a virtual gift icon database.

4. The method of claim 1 wherein the overlay comprises two or more components for temporarily concealing the gift icon, at least one of the components concealing the gift icon and each component having at least one of the active zones embedded therein.

5. The method of claim 4 wherein the least two or more components comprises a first component embedding a first active zone encapsulating a first removal action and at least a second component embedding a second active zone encapsulating a second removal action and wherein the removing step further comprises:
identifying the first active zone embedded in the first component;
activating the first removal action specified by the first active zone;
tracking completion of the first removal action resulting in removal of the first component;
identifying the at least a second active zone for removal of the second component repeating the identifying, activating, tracking for the at least a second component.

6. The method of claim 2 further comprising counting the control actions and removing a balance of the overlay within a predetermined number of counts.

7. The method of claim 2 further comprising timing the control actions and removing a balance of the overlay within a predetermined time.

8. The method of claim 1 wherein the overlay has one or more components selected from group consisting of a box closed with a lid, an envelope having a flap, and a pouch having an opening closed with a string.

9. The method of claim 8 further comprising virtually wrapping at least one of the one or more components with wrapping paper.

10. The method of claim 5 wherein the first component is an outermost component and the at least a second component is an inner component concealed by the first component, the second component being revealed upon removal of the first component.

11. The method of claim 10 further comprising at least a third component having a third active zone wherein the third component is an inner component concealed by the second component, the third component being revealed upon removal of the second component.

12. The method of claim 11 wherein the first component is a string, the second component is wrapping paper and the third component is a box having a lid for concealing the gift icon, the removing step further comprising:
identifying the first active zone embedded in the string and activating a first removal action specified by the first active zone which approximates untying the string from the inner wrapping paper and box;
identifying the second active zone embedded in the wrapping paper and activating a second removal action specified by second active zone which simulates removal of the wrapping paper from the box; and
identifying at the third active zone embedded in the lid and activating the removal action specified by the third active zone which simulated separating the lid from the box for revealing the gift icon.

13. The method of claim 1 wherein the notifying step comprises sending an electronic notification to the recipient, the electronic notification selected from a group consisting of an e-mail, text message, a voicemail message, and other electronic message.

14. The method of claim 1 wherein the notifying step comprises physically delivering to the recipient a notification containing a link or access code to the network resource.

15. The method of claim 1 wherein the concealing a gift icon further comprises concealing a personalized message from the online giver, the removing step revealing both the gift icon and the personalized message.

16. The method of claim 1 wherein the notifying step further comprises including instructions for removing the at least a portion of the concealing overlay from the virtual package.

17. The method of claim 1 wherein the notifying step further comprises including instructions for redeeming the gift associated with the gift icon.

18. The method of claim 1 wherein the removing step further comprises presenting audio symbolic of the removal actions.

19. The method of claim 1 wherein the gift is a physical asset.

20. The method of claim 1 wherein the gift is a digital asset.

21. An electronic gifting system, the system comprising:
a data store comprising one or more virtual gift icons for access by an online giver for selection of a gift icon, each of the one or more virtual gift icons corresponding to an asset;
a package customisation module enabling creation of a virtual package by temporarily concealing the selected gift icon with a concealing overlay selected from an overlay database, the overlay comprising at least one active zone embedded therein and responsive to the presence of a pointing device;
a notification module for notifying a recipient of the virtual package; and
a recipient module for access by the recipient to interact with the virtual package, the interaction comprising tracking the pointing device over the virtual package to identify correspondence of the pointing device with the at least one active zone embedded in the overlay and control action at the pointing device associated with at least one removal action specified by the at least one active zone for removal of at least a portion of the overlay from the virtual package for revealing the gift icon.

22. The system of claim 21 wherein the gift icon corresponds to a digital asset.

23. A computer readable non-transitory medium embodying a computer program for electronic gifting, the computer program comprising:
program code for creating a virtual package for temporarily concealing a virtual gift icon on a display with a concealing overlay, the gift icon being associated with a gift, the concealing overlay comprising at least one active zone embedded therein and sensitive to the movement and control actions of a pointing device; and
program code for tracking the movement an control actions of the pointing device over the virtual package for identifying the at least one active zone in the concealing overlay and activation of a removal control action specified by the at least one active zone for removal of at least a portion of the concealing overlay from the virtual package for revealing the gift icon.

24. A method for enabling electronic gift giving comprising:
creating a virtual package for display at a graphical user interface for temporarily concealing a virtual gift icon associated with a gift, the creating of a virtual package further comprising
selecting the virtual gift icon from a plurality of virtual gift icons;
selecting a concealing overlay selected from a plurality of concealing overlays for concealing the virtual gift icon;
notifying a recipient of the virtual package for directing the recipient to a location of the virtual package; and
receiving recipient input at a graphical user interface corresponding to the location of the virtual package, the recipient input simulating unwrapping of the virtual package for removing at least a portion of the concealing overlay and revealing the virtual gift icon.

25. The method of claim 24 wherein the recipient input for simulating unwrapping of the virtual package further comprises:
tracking of a pointing device of the recipient for movement of the pointing device over active zones of the concealing overlay; and
tracking control actions of the pointing device for triggering removal of the concealing overlay.
